(19) United States
(12) Patent Application Publication
(10) Pub. No.: US 2007/0189793 A1
(43) Pub. Date: Aug. 16, 2007

(54) Toner and additive removal system for copier or printer

(75) Inventors: Bruce E. Thayer, Webster, NY (US); Paul W. Morehouse, Webster, NY (US); Michael D. Thompson, Rochester, NY (US)

Correspondence Address: JAMES J. RALABATE, 5792 MAIN STREET, WILLIAMSVILLE, NY, 14221, US

(73) Assignee: Xerox Corporation

(21) Appl. No.: 11/353,259

(22) Filed: Feb. 14, 2006

(51) Int. Cl. G03G 15/08; G03G 21/00

(52) U.S. Cl. 399/55; 399/71; 399/353; 399/354; 399/285; 399/279

(57) ABSTRACT

This is an electrophotographic marking system that effectively cleans residual toner and toner additives from the surface of a photoreceptor. This cleaning process reduces ghosting problems that had been encountered in final copies produced by electrophotographic systems such as in copiers, printers and duplicators. This cleaning is accomplished by expedients such as increasing a cleaning brush bias, and by increasing the surface area of cleaning brushes used in the system. In addition, the development process is desensitized to the development of ghosting. This desensitizing is accomplished by expedients such as increasing the gap between the development roll and the photoreceptor and by reducing the AC development electrical bias.

The present invention relates to electrostatographic marking systems including copiers or printers, and more particularly, to improved toner and toner agent removal expedients for cleaning residual toner and toner agents from the surface of the photoreceptor of a marking system.

### BACKGROUND

Xerography is one type of an electrostatographic marking process. In this process, a uniform electrostatic charge is placed upon a photoreceptor surface. The charged surface is then exposed to a light image of an original to selectively dissipate the charge to form a latent electrostatic image of the original. The latent image is developed by depositing finely divided and charged particles of toner upon the photoreceptor surface. The charged toner being electrostatically attracted to the latent electrostatic image areas to create a visible replica of the original. The developed image is then usually transferred from the photoreceptor surface to a final support material, such as paper, and the toner image is fixed thereto to form a permanent record corresponding to the original.

In a typical xerographic copier or printer, a photoconductor surface is generally arranged to move in an endless path through the various processing stations of the xerographic process. When the photoreceptor surface is reusable, the toner image is then transferred to a final support material, such as paper, and the surface of the photoreceptor is prepared to be used once again for the reproduction of a copy of an original. Although a preponderance of the toner image is transferred to the paper during the transfer operation, some of the toner and toner agents forming the image are unavoidably left behind on the photoconductor surface. These remaining toner and toner agents on the photoreceptor surface after the image transfer are referred to as residual toner and residual additives or agents. Residual toner also includes any patches or bands of toner not transferred to the final support material. Many typical copiers or printers use particularly placed and developed patches or bands of toner for process control, and these patches or bands of toner must also be removed by the toner removal apparatus. Thus, all residual toner and agents must be removed from the photoreceptor to prevent degrading or ghosting on subsequent copies reproduced by the copier or printer. Optimally, the residual toner and agents are removed without re-depositing the toner onto the photoreceptor or smearing the toner on the photoreceptor surface as an unacceptable film.

One widely accepted method of cleaning residual toner from the surface of a photoreceptor of a typical copier or printer is by means of a cylindrical brush rotated in contact with the photoreceptor surface at a relatively high rate of speed. Generally, a rotatable brush is mounted in interference contact to the photoreceptor surface to be cleaned, and the brush is rotated so that the brush fibers continually wipe across the photoreceptor. Electrical bias applied to conductive brush fibers aids in removing and transporting cleaned material away from the photoreceptor surface. In order to reduce the dirt level within the brush, a flicker bar and vacuum system is provided which removes residual toner and toner agents from the brush fibers and exhausts the toner and toner agents from the cleaner. Unfortunately, the brush becomes contaminated with toner and toner agents and, after extended usage, needs to be replaced. With increased processing speeds of copiers and printers and the expanded use of toner agents, the foregoing brush cleaning techniques are not practical without substantial improvements.

In today's marking systems toners are customized to contain certain toner agents to improve charge control toner transfer, flow control and other desirable variations in the toner. Some agents include TiO₂, SiO₂, Zinc stearates and other known toner agents. There have been substantial ghosting problems in these systems due to accumulation of these toner additives on the photoreceptor. While most prior art cleaning stations and electrostatic brush cleaners have been concerned with toner removal, it has become apparent that new and improved cleaning systems are needed to remove both toner and toner agents or additives from the photoreceptor. Many difficulties were encountered to accomplish this primarily because of the very small size and relatively high charge of the toner additives or agents. This has been further complicated because for a functional solution, the toner additive cleaning latitude must sufficiently overlap the toner particle cleaning latitude. In addition, the removal of these toner agents becomes further complicated since the agents are about 100 times smaller than the toner particle. While these agents are a dust size, they are highly charged and easily cling to the surface of the photoreceptor. Efficient removal of these toner agents is necessary to prevent or minimize ghosting on the final copy paper surface produced by the marking system or apparatus.

### SUMMARY

Ghosting can be effectively measured by a reliable method used wherein the imaged paper surface is scanned and compared with images having no ghosting. A numerical value is given as a result of this scan, the higher the number the more intense the ghosting. This disclosure will refer to these ghosting numbers; i.e. a value of 7.0 indicates more ghosting than a value of 2.0, for example.

There are several considerations or expedients in the present embodiments that are found to effectively remove the toner and the toner additives to thereby very effectively eliminate or minimize this ghosting problem. It has been found that if at least one of the following expedients is used, removal of toner additives is improved and ghosting will be reduced substantially: A. improvement is accomplished by increasing the brush bias to increase the electrostatic forces attracting additives to the brush fibers, B. increase the cleaning capacity of the brush by increasing the surface area of the cleaner brush in order to retain more additives (agents) for transport from the photoreceptor surface, C. substantially increase the distance of the photoreceptor from the developer roll to reduce the amount of toner additive scavenging in development and D. decrease development AC bias to reduce the sensitivity to ghost development.

Obviously, using all of the above expedients A-D provides in an embodiment a very effective means for removing additives and reducing ghosting. These A-D expedients can obviously be used with other means if suitable for removing additives and toner.

The electrostatic brush (ESB) cleaner was modified to enable cleaning of charged additive particles, as well as toner particles. Brush bias was increased to increase the electrostatic forces attracting additives to the brush fibers and to increase the capacity of each fiber to retain additives for transport from the photoreceptor surface. The weave density of the brush was also increased to increase the cleaning capacity of the brush. These modifications enable cleaning and detoning of both toner and additives. Removal of the additives from the photoreceptor surface eliminated the ghosting problem. The brush bias required for toner additive cleaning could be enabled only when needed based on additive cleaning stresses, such as specific environmental zones, developer age and throughput. For a multiple brush ESB cleaner, the same modifications can be made to the wrong sign cleaning brush to clean wrong sign toner additives.

Throughout this disclosure and claims the following are included in each definition:
A. “Increased brush bias” includes a bias of at least 300v up to an electrical breakdown or arcing caused by said increased voltage. Usually arcing occurs at about from 500v to 700v; however, arcing can easily be measured and determined as the upper limit of this increased brush bias. In one embodiment about 400 Volts was found to be very effective, while a bias of about 300 Volts was found to be less effective.
B. “Increased surface area of the cleaner brush” includes any suitable means to increase this area. This increase can be accomplished by decreasing the pile height of the fibers, increasing the perimeter length of the fiber cross-section, or increasing the number of fibers or weave density in the brush; i.e. at least 40,000 fibers per square inch up to 145,000 fibers per square inch. In one embodiment 60,000 fibers per square inch was found very effective to remove toner and additives, 90,000 fibers per square inch was also found very effective to remove toner and additives, in a third embodiment 145,000 fibers per square inch was extremely effective in removing toner and toner additives (agents) and substantially reducing ghosting.
C. Increased distance from the photoreceptor to the developer roll includes a distance of at least 350 Microns to about 500 Microns.
D. Decrease development AC peak bias from 1,000 Volts to 700 Volts.

As earlier noted, using the above A-D expedients alone or with other suitable expedients to remove toner additives and minimize ghosting can be in some cases desirable.

All of the materials disclosed herein such as toners, toner additives, photoreceptors, cleaner brush, etc. are general knowledge so that details on these materials are not warranted. Cleaner brushes, for example, are made from known materials including nylon and acrylics, toners include polystyrene, polyethylene, n-butyl, methacrylates, and photoreceptors include any known material that will hold a charge and will dissipate a charge in the presence of light.

Small particulate additives are typically blended onto the surface of toner particles. The additives are used to aid in control of toner charging, toner flow, transfer and/or cleaner blade lubrication. Intentionally or not, many of these additive particles are knocked free of the toner particles. The free additives then develop onto the surface of the photoreceptor. Additives having the same sign as the toner will predominantly accumulate on the photoreceptor in areas where toner is developed. Additives having the opposite sign as the toner will accumulate in the background areas of an image. This disclosure includes opposite sign and same sign toner and additives. In testing several development systems, a constant ghosting problem was present. The cause of the ghosting was determined to be right sign toner additives on the photoreceptor surface that were not cleaned by the electrostatic brush cleaner. An (electrostatic brush) ESB cleaner modification together with other expedients was needed to enable cleaning both toner and additives and thereby reduce ghosting.

This disclosure describes the changes to an ESB cleaner right sign cleaning brush that enable cleaning of both toner and right sign toner additives. The same changes can be applied to the wrong sign cleaning brush to enable cleaning of wrong sign toner additive particles as well as wrong sign toner. However, because development of wrong sign particles either toner or additives, is much less than right sign particles and the right and wrong sign brushes are normally common, the wrong sign cleaning brush typically well exceeds its toner cleaning requirement. The magnitude of the changes to the wrong sign cleaning brush, e.g., increasing brush weave density, may not be as large as required for the right sign cleaning brush.

Electrostatic brush cleaner fibers remove toner particles from the photoreceptor surface by mechanically contacting and detaching the adhered particles. The conductive brush fibers are biased to the opposite polarity of the toner so that an electrostatic field is created between the brush fiber and the grounded photoreceptor substrate. The charged toner particles are electrostatically attracted to the biased brush fiber. The electrostatic adhesion forces holding the toner particles to the fibers allow the rotating brush to transport the toner particles away from the photoreceptor surface. The toner particles are then cleaned from the brush fibers by one of two processes. Electrostatic detoning brings the biased brush fiber into contact with a rotating, biased roll having a dielectric coating. The electrostatic detoning roll is biased at the same polarity as the brush, but to a higher magnitude. Toner then electrostatically transfers from the brush fibers to the electrostatic roll surface. Alternatively, air detoning removes toner particles from the brush fibers by using impact forces to knock them into an air stream. The impact forces are generated by a flicker bar in interference contact with the rotating brush. Air flows around the flicker bar are optimized for efficient brush fiber detoning and toner transport.

Electrostatic brush cleaning latitude, for a given brush design, is measured in brush bias and preclean current. Preclean current is a surrogate for toner charge and brush bias, along with toner charge, is a surrogate for the electrostatic force required to hold toner particles onto the fibers. For a given brush bias and preclean current, brush design influences the maximum toner density that can be cleaned. Brush design parameters include: brush diameter, pile height, fiber denier, fiber material type, pile weave density, brush speed and brush to photoreceptor interference. In addition to cleaning requirements, there are limitations on brush drag force against the photoreceptor, brush fiber set, brush fiber entanglement and manufacturing limitations on weave density.

Brush bias latitude is limited on the high end by electrical breakdown between the biased brush fiber tips and the photoreceptor surface. The charge on residual toner particles after transfer is typically broadly distributed with a mean value near zero. The purpose of corona device applied preclean current is to shift the distribution to right sign (negative polarity in this case). Increases in preclean current shift the distribution to higher right sign mean charges. However, the distribution always retains a small wrong sign tail. Preclean latitude is limited on the low end by the minimum preclean current required to shift the toner charge distribution in the right sign direction enough to obtain acceptable cleaning.

The preceding discussion outlined the concerns for simultaneous ESB cleaning of toner and toner additive particles. A test was performed to investigate whether or not a cleaning latitude space could be found for cleaning toner additives that sufficiently overlapped the toner cleaning latitude. Additional testing was performed to determine whether or not toner additive particles that were cleaned by the brush could be detoned successfully.

The evaluation of toner additive particle cleaning was done by running a standard ghosting test on modified Nuvera machines. Earlier testing had verified the relationship between high levels of toner additive particles left on the photoreceptor after the cleaner and high ghosting level scores. Therefore, low ghosting level scores indicate good cleaning of toner additive particles and higher ghosting level scores indicate progressively poorer levels of toner additive particle cleaning. A measurement technique to quantify ghosting on prints was developed based on the change in the L* value caused by the residual additives.

Detoning testing is generally very lengthy. To determine if detoning is adequate, the weight of the cleaning brush is monitored over its life to quantify how much material has accumulated in it. In this test, a short cut was used that is reasonable for air detoned ESB cleaners. First the cleaner brush is detoned and then disabled so that particles accumulate in the brush. Under these conditions particle cleaning will be degraded due to the presence of undetoned particles on the brush fiber tips. Because of poor toner additive particle cleaning the ghosting level scores will increase. Then, the detoning system is returned to its nominal operating condition. If the air detoning system is effective for detoning toner additive particles, then the accumulated particles within the brush will be removed. Removal of toner additive particles from the brush fiber tips will improve toner additive particle cleaning and lower the ghosting level score.

Throughout this disclosure and claims various terms are used to define the “Solution” of embodiments of this invention. These terms are defined as follows:

“Solution” or “Expedient” or “cleaning expedient” consists of one or more of the following three parts:

1. “Increase cleaning capacity” to enable removal of toner additives as well as toner from the photoreceptor.

2. “Decrease development scavenging” to minimize the creation of ghosting potential differences on the photoreceptor.

3. “Decrease the sensitivity of development” to ghosting potential differences on the photoreceptor.

Each part can be accomplished by one or more of the following:

1. “Increase cleaning capacity” A. increase electric field attracting particles to brush, increase brush bias from 250V to at least 300V but limited by the electrical breakdown voltage between the brush fiber tips and the photoreceptor. Similar increases in brush bias will be used with other original brush biases, B. increase surface area of brush available to clean particles, B1. increase brush speed from 200 RPM to at least 300 RPM with an upper limit created by unacceptable toner emissions from the cleaner. Similar brush speed increases will be made when starting from a different original brush speed, B2. increase brush weave density from 30,000 fibers per inch² to at least 40,000 fibers per inch² with an upper limit determined by brush drag on the photoreceptor and the fabric manufacturing limit for 10 denier brush fibers on a 60 mm diameter brush. Brushes of different deniers and diameters can be similarly modified, B3. increasing brush fiber size from 10 denier to at least 15 denier with the maximum size limited by increases in the brush drag on the photoreceptor and set of the brush fibers caused by a stiffer brush formed from the larger size fibers. The original brush is 60 mm in diameter with a 13 mm pile height. Different limits on increases in brush fiber sizes will exist for brushes of different sizes, B4. decreasing brush fiber size (denier) and increasing brush weave density enables a higher surface area brush without a corresponding increase in brush stiffness. The original 10 denier brush meets the minimum ghosting requirement when the weave density is increased from 30,000 fibers per inch² to 41,000 fibers per inch². For small fibers sizes, the weave density must be at least equal to 130,000 fibers per inch² divided by the square root of the fiber size in denier [130,000/(dpf)]. Weave density can be increased up to the manufacturing limit for a stable pile fabric. Fiber size can be reduced until manufacturing and cost limits are reached.

When the term “increase cleaning capacity” is used in this disclosure and claims, A and B above are included. When the term “increase surface area of the brush” is used, expedients B1, B2, B3 and B4 each above or in any combination are included.

2. “Decrease development scavenging” includes Increase development gap from at least 350 um to at least 425 um.

3. “Decrease sensitivity of development” to ghosting includes Decrease development AC bias from 1000V p-p to 600V p-p.

In all of the above expedients, numbers are based upon systems with specific size components. Modifications can easily be calculated for systems when different size components are used.

Table 1 shows the three cleaner brushes used in the testing. The Test I brush is the current prior art machine brush configuration. The Test II brush has been modified to use expedients of this invention. Physically the Test II and Test III brushes are different from the Test I brush in weave density and pile height. The Test III brushes are reworked brushes that were made for testing. The pile height is the same as the Test II brush but the fibers are smaller and woven at a higher surface density. The fourth brush listed in Table 1 is the Design Choice. This brush was proposed as an optimization considering cost and performance.

The Performance section of Table 1 lists a combination of test results and model projections for each of the brushes. Ghosting or toner additive particle cleaning and detoning were determined through testing. The rest of the performance attributes were determined through use of ESB cleaning models. Ghosting with a measured level of 2 or higher was considered unacceptable.

Increasing brush bias and weave density enable the ESB to clean toner additive particles. The selected brush bias was 400 Volts. This is significantly higher than the prior art baseline brush bias of 250 Volts required for cleaning toner particles. The breakdown potential for the cleaner brush in prior art is between 500 Volts and 700 Volts. The 100 Volts to 300 Volts between the cleaner brush bias and the breakdown potential provides an adequate tolerance for a functional cleaner design.

With 400 Volts brush bias, good toner additive cleaning was obtained by doubling the weave density of the baseline Test I brush. This weave density increase (Test II) resulted in a 50% increase in cleaning capacity and fiber strikes. A much larger weave density increase to 145k fibers/in² resulted in a very large improvement in toner additive cleaning capacity. The Design Choice brush is projected to provide toner additive cleaning capability nearly as good as the 145K WD brush at a reduced cost.

“Fiber strikes” indicates how many fibers hit the toner or toner additive particle to be removed. Photoreceptor (P.R.) abrasion and filming were measured as “ok” being acceptable.

TABLE 1
Cleaner Brush Solution

| | | | | | A final |
|---|---|---|---|---|---|
| | | Start- | | | design |
| | | Test I | | | choice |
| | | Prior | Test | Test | Embodi- |
| | | Art | II | III | ment |
| Brush Design | | | | | |
| Fiber Material | | SA-7 | SA-7 | SA-7 | SA-7 |
| Fiber Size | Denier | 10 | 10 | 6 | 6 |
| Weave Density | Kfibers/ | 30 | 60 | 145 | 90 |
| | in² | | | | |
| Pile Height | mm | 13 | 16.5 | 16.5 | 12 |
| Brush Diameter | mm | 60 | 60 | 60 | 60 |
| Core Diameter | mm | 32 | 25 | 25 | 34 |
| Brush Bias | Volts | 250 | 400 | 400 | 400 |
| Performance | | | | | |
| Ghosting (test | Ghost | 3.25 | 1.59 | 0.75 | 0.97 |
| result) | level | | | | |
| Drag | g | 208 | 218 | 190 | 275 |
| Cleaning | % of | 100 (ref.) | 64 | 34 | 40 |
| | capacity | | | | |
| P/R abrasion | | ok | ok | ok | ok |
| P/R filming | | ok | ok | ok | ok |
| Fiber Strikes - | | 6.93 | 10.84 | 26.19 | 22.11 |
| toner | | | | | |
| Fiber Strikes - | | 0.17 | 0.27 | 0.65 | 0.55 |
| Additive | | | | | |

### BRIEF DESCRIPTION OF THE DRAWINGS

FIG. 1 illustrates a complete electrostatic marking system block diagram where a cleaning embodiment of this invention can be used.

FIG. 2 illustrates a cleaner brush system useful in the present invention.

FIG. 3 illustrates the distance relationship between the photoreceptor (belt) and the developer rolls.

FIGS. 4A and 4B illustrate brush cleaning results of the photoreceptor with and before the present invention.

FIG. 5 is a table indicating specific ghosting results using expedients of this invention.

### DETAILED DISCUSSION OF DRAWINGS AND PREFERRED EMBODIMENTS

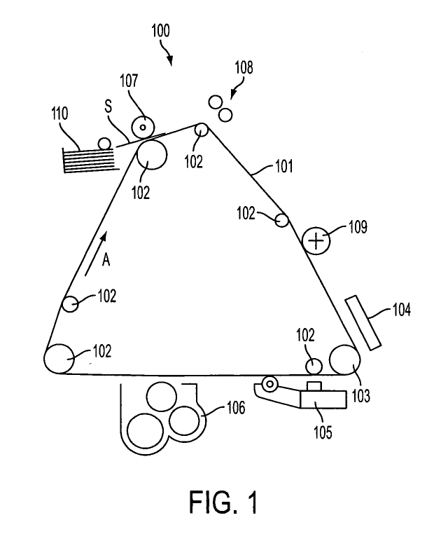

In FIG. 1 a total electrophotographic marking system 100 is illustrated. FIG. 1 shows a block diagram of an electrophotographic (EP) image-forming machine 100. A photoconductor 101 is operatively mounted on support rollers 102. A motor 103 moves the photoconductor 101 in the direction indicated by arrow A. A primary charger station 104, an exposure station 105, a toning station 106, a transfer charger 107, a fusing station 108, a pre-clean corotron 124, and a cleaner 109 are operatively disposed about the photoconductor 101. While not shown, the EP image-forming machine 100 can have a separation charger (which may be incorporated with the transfer charger 107), a densitometer, microprocessor control, and other features. A paper feed tray is shown 105, a developer station 106, a fusing station 108, and a cleaning station 109.

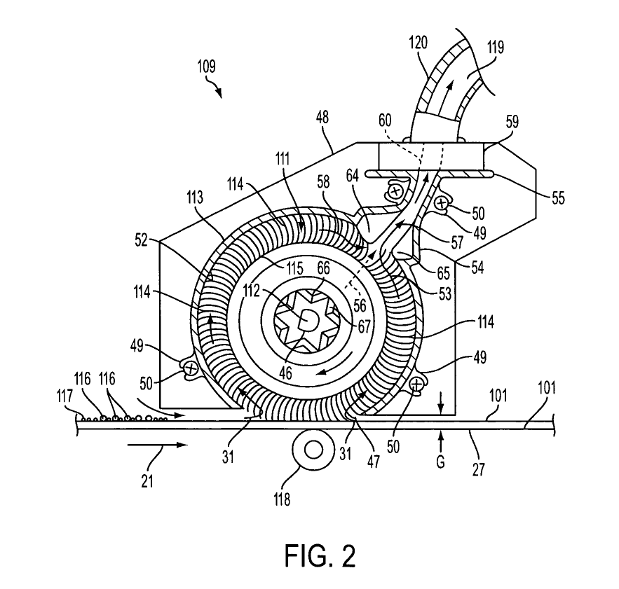

In FIG. 2 an enlarged cleaner station 109 is shown having a cleaner brush 111 as a single brush arrangement. Obviously, two or more brushes may be used, if desirable. The brush 111 is cylindrically shaped and adapted for rotation along its axis 112 at about 200-300 RPM. The toner and additive removal apparatus has an aluminum housing 113 that surrounds the rotatable brush 111. Brush fibers 114 extend from the interior conductive sleeve 115 of the brush 111 into interference cleaning contact with the photoreceptor 101. The air flow generated by vacuum 119 forces the air flow containing brush flicked out toner 116 and additives 117 through conduit 120 for removal from systems.

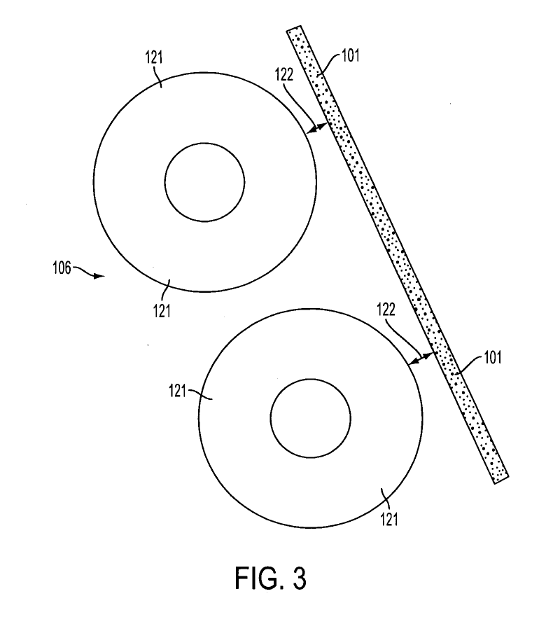

In FIG. 3 the developer rolls 121 of developer station 106 are shown as they are separated from the photoreceptor belt 101. As earlier noted, a gap 122 of at least 350 Microns is used in an embodiment as an expedient to preventing ghosting. A gap 122 of from about 350 Microns to about 500 Microns was effective to prevent the development system from revealing the ghost image. Increasing this gap to at least 350 Microns in the embodiment effectively prevents the scavenging of residual additives during the development step which thereby prevents any development of the ghost image underneath the highly charged additive layer. This modification of the development station works together with the measures taken in the cleaning station to cooperatively prevent ghosting necessitated because the cleaning step does not clean 100% of the residual additives.

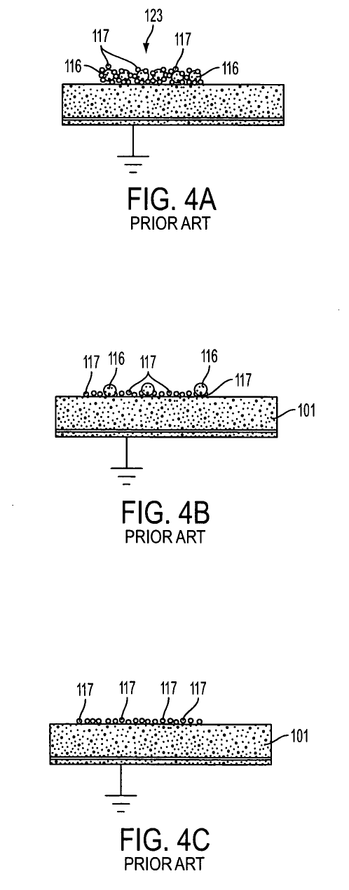

In FIG. 4A a schematic showing a photoreceptor cleaning sequence of the prior art is depicted. The developed image 123 contains toner 116 and toner additives 117. Note that very little toner additive 117 is removed after the cleaning step of the prior art. In FIG. 4B, the expedients A-D of the present invention above noted were used in the marking system, i.e. at least one of the following: an increased brush bias, an increased brush surface area, an increased distance or gap between the developer roll and the photoreceptor and a decrease in developer AC voltage were used. Very little, if any, residual toner 116 and toner additive 117 remains after the cleaning step and the developer changes minimize the sensitivity to ghosting for any toner additive particles that may remain after cleaning.

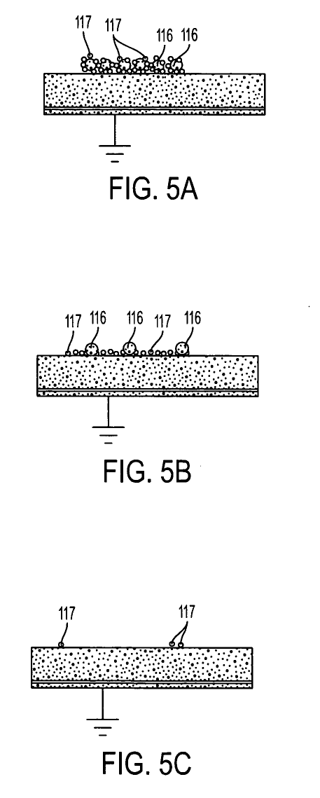

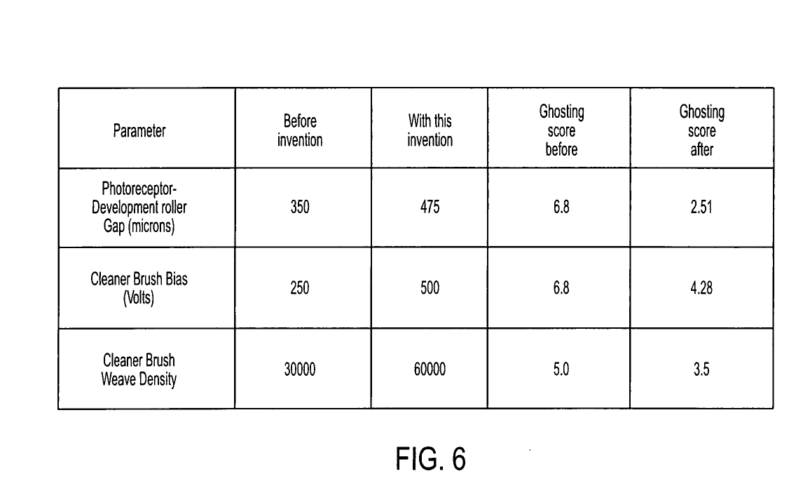

In FIG. 5 a Table 2 is shown indicating specific ghosting results using an embodiment of this invention as compared to the prior art. In this embodiment a developer roll to photoreceptor gap of 475 Microns, a cleaner brush bias of 500v and a cleaner brush density of 60,000 was used. In each of these A-D expedients a significant reduction of ghosting was accomplished. When an increased developer-roll gap, together with an increased cleaner brush bias and an increased cleaner brush weave are all used, a very significant reduction in ghosting 1.5 was obtained over an original ghosting of 6.8. While all significant ghosting reductions caused individually by an increased gap (2.51), an increased cleaner brush bias (4.28) and an increase in brush weave density (3.5) were obtained, combining these three expedients provided the best ghost reduction results (1.5).

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electrophotographic marking system adapted to reduce ghosting in final copies from said system, said system comprising in an operative arrangement, a charging station, an exposure station, a development station and a cleaning station, said development station comprising at least one developer roll adjacent to a photoreceptor surface and having a gap there between, said cleaning station comprising at least one rotating cleaning brush, said system comprising at least one expedient selected from the group consisting of an increase in cleaning capacity, a decrease in development scavenging, and decrease in the sensitivity of development, said decrease in development scavenging including said gap having a distance of at least 350 Microns and said decrease in the sensitivity of development including decreased development of an AC bias from about 1000V p-p to about 600V p-p.

2. The system of claim 1 wherein said increase in cleaning capacity comprises an expedient selected from the group consisting of increasing brush bias to at least about 300V and increasing the surface area of said brush.

3. The system of claim 1 wherein said increase in cleaning capacity comprises increasing brush bias to at least about 300V up to a voltage where there is an electrical breakdown between said brush and said photoreceptor.

4. The system of claim 1 wherein said increase in cleaning capacity comprises increasing the brush speed to at least about 300 RPM.

5. The system of claim 1 wherein said increase in cleaning capacity comprises an increase in brush weave density to at least about 40,000 fibers per square inch.

6. The system of claim 1 wherein said increase in cleaning capacity comprises an increase in brush fiber size to at least about 15 denier.

7. The system of claim 1 wherein said increase in cleaning capacity comprises a brush with a decreased brush fiber size (denier) and an increased brush weave density to about 40,000 fibers per square inch.

8. An electrophotographic marking system adapted to reduce ghosting in final copies produced from said system, said system comprising in an operative arrangement, a charging station, an exposure station, a development station, and a cleaning station, said development station comprising at least one developer roll adjacent to a photoreceptor surface and having a gap there between, said cleaning station comprising at least one rotating cleaning brush, said system comprising at least one cleaning expedient selected from the group consisting of: A. said gap being at least about 350 Microns to at least about 500 Microns; B. a development AC bias decreased to no more than about 600V p-p; C. an increase of said brush bias to at least from about 300V to an electrical breakdown voltage between said brush and said photoreceptor, and D. a brush having an increased surface area available to clean said photoreceptor.

9. The system of claim 8 wherein D. brush having an increased surface area is provided by at least one member selected from the group consisting of an increase speed of at least about 300 RPM, an increase brush weave density of at least about 40,000 fibers per square inch, an increase brush fiber size to at least about 15 denier, and a brush with an increased weave density of at least about 40,000 fibers together with a decrease in brush fiber size (denier).

10. The system of claim 8 wherein said increased weave density together with said fiber size denier provides a higher surface area brush without a corresponding increase in brush stiffness.

11. The system of claim 8 wherein said brush bias is about from about 300V to about 700V.

12. The system of claim 8 wherein said increased surface area of said brush comprises a brush weave density of from about 30,000 to about 60,000 fibers per square inch.

13. An electrophotographic marking system adapted to reduce ghosting in final copies from said system, said system comprising in an operative arrangement, a charging station, an exposure station, a development station and a cleaning station, said development station comprising at least one developer roll adjacent to a photoreceptor surface and having a gap there between, said cleaning station comprising at least one rotating cleaning brush, said system comprising expedients enabled to reduce residual toner and toner additives from said photoreceptor surface, said system comprising at least one cleaning expedient selected from the group consisting of a decrease in an AC development bias in said system, an increase cleaner brush bias, and an increase brush cleaning surface area, said expedients also comprising in an operative arrangement wherein said gap has a distance of at least about 350 Microns, said cleaning brush increased surface area comprising a weave density of at least about 40,000 fibers per square inch, and wherein said cleaning brush bias has a bias voltage of at least about 300 Volts, all of said expedients each enabled to provide an increased removal of residual toner and toner additives from said photoreceptor surface and thereby substantially reduce ghosting in final copies produced from said system.

14. The system of claim 13 wherein said cleaner brush bias voltage is from at least about 300 Volts up to an electrical breakdown point or arcing caused by said voltage.

15. The system of claim 13 wherein said cleaner brush bias voltage is from about 300 Volts to about 700 Volts.

16. The system of claim 13 wherein said increased surface area comprises from about 40,000 to about 100,000 fibers per square inch.

17. The system of claim 13 wherein said gap is from about 350 Microns to about 500 Microns.

18. The system of claim 13 wherein said increased surface area comprises a brush weave density of from about 30,000 to abut 60,000 fibers per square inch.

19. The system of claim 13 wherein said decrease in AC development bias is to no more than about 600V p-p.
